(19) United States
(12) Patent Application Publication
(10) Pub. No.: US 2012/0019515 A1
(43) Pub. Date: Jan. 26, 2012

(54) DISPLAY METHOD

(75) Inventors: Yue-Li Chao, Taoyuan County (TW); Chun-Chieh Chiu, Taoyuan County (TW); Chien-Hung Chen, Taipei County (TW)

(73) Assignee: CHUNGHWA PICTURE TUBES, LTD., Taoyuan (TW)

(21) Appl. No.: 12/945,900

(22) Filed: Nov. 15, 2010

Related U.S. Application Data
(63) Continuation of application No. 12/939,177, filed on Nov. 4, 2010.

(30) Foreign Application Priority Data
Jul. 21, 2010 (TW) 99124011

(51) Int. Cl. G06T 15/00

(52) U.S. Cl. 345/419

(57) ABSTRACT

A display method thereof is provided. The display method includes following steps. In a first display period of a left eye frame period, first display data are read from a memory unit, and the left eye frame is displayed accordingly. In a second display period of the left eye frame period, second display data is provided and a black frame is displayed accordingly. In a third display period of a right eye frame period, third display data are read from the memory unit, and the right eye frame is displayed accordingly. In a fourth display period of the right eye frame period, the second display data is provided and the black frame is displayed accordingly. As such, writing-in time and display time of frames can be increased.

### CROSS-REFERENCE TO RELATED APPLICATION

This is a continuation application of and claims the priority benefit of patent application Ser. No. 12/939,177, filed on Nov. 4, 2010, which claims the priority benefit of Taiwan application serial no. 99124011, filed on Jul. 21, 2010. The entirety of each of the above-mentioned patent applications is hereby incorporated by reference herein and made a part of this specification.

### BACKGROUND OF THE INVENTION

1. Field of the Invention

The invention generally relates to a three-dimensional (3D) display technique, and more particularly to a display method thereof.

2. Description of Related Art

As technology progresses and advances, people's needs for fulfillment on a material and a spiritual level have not lessened but instead, have increased. People are eager to express their imagination through a three dimensional (3D) display, so as to vividly experience an effect of being personally in a scene. Therefore, how to present a 3D image or video on a display has become one of the major objectives to be achieved by applying current 3D display techniques.

In terms of outer appearances, 3D display techniques can be roughly divided into stereoscopic techniques which require a user to wear a specially designed pair of glasses, and auto-stereoscopic techniques which directly allow viewing with a naked eye. In particular, the specially designed glasses adopted in the stereoscopic 3D display techniques can be divided into color filter glasses, polarizing glasses, shutter glasses, and so forth. The operating principle of a stereoscopic 3D display utilizes the eye glasses to select the left and right eye frames displayed on the 3D display, so that the left eye and the right eye respectively see the left and right eye frames for generating a 3D visual effect.

In order to enhance the 3D visual effect and to prevent a residual image, a typical design usually entails opening the shutter glasses after the image is fully displayed. In a frame period, most time is spent on writing display data into pixels, i.e. most time is spent on charging the pixels. In the most favorable condition of writing the display data into the pixels, display time at most accounts for 32% of the entire frame period, and thus the brightness of the 3D images is subject to the time of writing the display data into the pixels. To enhance brightness of the 3D images, backlight luminance needs to be improved, i.e. the number of light emitting sources or brightness of the light source is required to be increased, which increases costs of the display. On the other hand, to shorten the writing-in time of display data, overdriving techniques are often applied in the display to build up an overdriving table. Thereby, overdriving data can be found based on previous display data and existing display data of each pixel. As provided above, the overdriving table is a square of the gray scale range of the frame. That is to say, the overdriving table occupies significant memory space.

### SUMMARY OF THE INVENTION

The invention is directed to a display method of a 3D display capable of increasing displaying time of frames, so as to enhance image luminance and contrast.

The invention provides a display method suitable for a 3D display having a memory unit. The display method includes following steps. In a first display period of a left eye frame period, first display data are read from a memory unit, and the left eye frame is displayed accordingly. In a second display period of the left eye frame period, second display data is provided and a black frame is displayed accordingly. In a third display period of a right eye frame period, third display data are read from the memory unit, and the right eye frame is displayed accordingly. In a fourth display period of the right eye frame period, second display data is provided and the black frame is displayed accordingly.

According to an embodiment of the invention, the step of displaying the left eye frame includes opening a left eye glass of a pair of shutter glasses and shutting a right eye glass of the pair of shutter glasses in the 3D display; writing the first display data into a display panel of the 3D display.

According to an embodiment of the invention, the step of displaying the right eye frame includes opening a right eye glass of a pair of shutter glasses and shutting a left eye glass of the pair of shutter glasses in the 3D display; writing the third display data into a display panel of the 3D display.

According to an embodiment of the invention, the second display data are written row by row into a display panel of the 3D display.

According to an embodiment of the invention, the second display data of the black frame are simultaneously written into a plurality of pixels in a display panel of the 3D display.

According to an embodiment of the invention, a display panel of the 3D display is divided into a plurality of display regions, and the second display data of the black frame are sequentially written into each of the display regions of the display panel.

According to an embodiment of the invention, a display panel of the 3D display is divided into a plurality of display regions, each of the display regions respectively corresponds to a time compensation table, the first display data, the second display data and the third display data are written into each of the display regions, and gray scale values of the display data written into each of the display regions are adjusted based on the corresponding time compensation table.

According to an embodiment of the invention, the display method further includes receiving the first display data and the third display data and writing the first display data and the third display data into the memory unit.

According to an embodiment of the invention, the second display period is shorter than the first display period, and the fourth display period is shorter than the third display period.

According to an embodiment of the invention, the first display period is equal to the third display period, and the second display period is equal to the fourth display period.

Based on the above, in the display method thereof, the left eye frame and the right eye frame are spaced by the black frame, and the writing-in time and the display time of the black frame are shortened, so as to increase the writing-in time and the display time of the left eye frame and the right eye frame. As such, the brightness and contrast of the left eye frame and the right eye frame can be enhanced, and the size of the overdriving table can be reduced.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic system diagram of a 3D display according to an embodiment of the invention.

FIG. 2 is a time sequence diagram of driving a left eye glass and a right eye glass in a pair of shutter glasses depicted in FIG. 1 according to an embodiment of the invention.

FIG. 3 is a schematic view illustrating regions of a display panel 170 depicted in FIG. 1 according to an embodiment of the invention.

FIG. 4 is a schematic view illustrating a plurality of time compensation tables according to an embodiment of the invention.

FIG. 5 is a flowchart illustrating a display method of a 3D display according to an embodiment of the invention.

### DESCRIPTION OF EMBODIMENTS

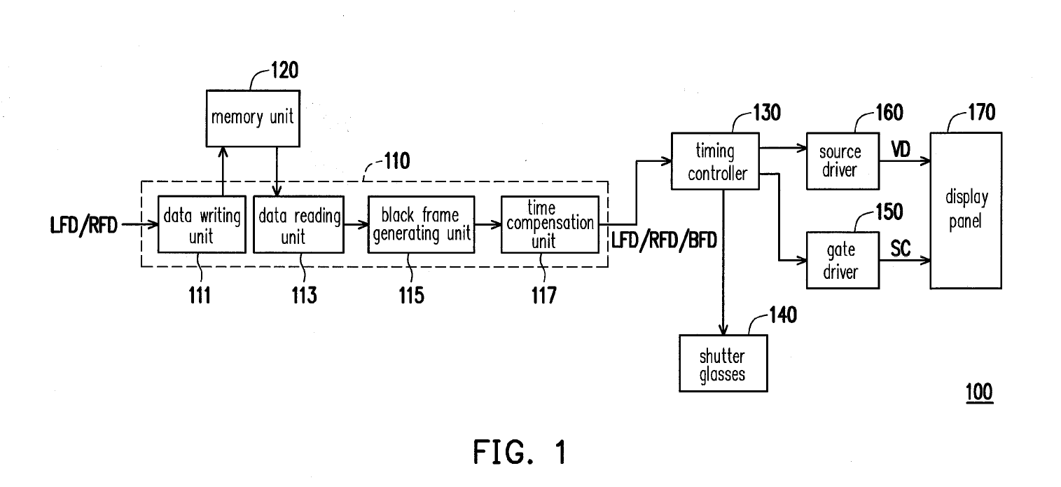

FIG. 1 is a schematic system diagram of a 3D display according to an embodiment of the invention. With reference to FIG. 1, the 3D display 100 of this embodiment includes a signal processing unit 110, a memory unit 120, a timing controller 130, a pair of shutter glasses 140, a gate driver 150, a source driver 160, and a display panel 170. The signal processing unit 110 is coupled to the memory unit 120 and receives display data LFD (i.e. first display data) of a left eye frame or display data RFD (i.e. third display data) of a right eye frame. The signal processing unit 110 stores the display data LFD of the left eye frame and the display data RFD of the right eye frame through the memory unit 120. In addition, the signal processing unit 110 outputs the display data LFD of the left eye frame, the display data RFD of the right eye frame, or display data BFD (i.e. second display data) of a black frame to the timing controller 130.

The timing controller 130 is coupled to the pair of shutter glasses 140, the gate driver 150, and the source driver 160. The timing controller 130 controls the pair of shutter glasses 140 to open one of the left eye glass or the right eye glass and shut the other based on the display data LFD of the left eye frame or the display data RFD of the right eye frame received by the timing controller 130. Besides, the timing controller 130 controls the gate driver 150 to output a plurality of scan signals SC based on the display data LFD of the left eye frame, the display data RFD of the right eye frame, or the display data BFD of the black frame received by the timing controller 130. The timing controller 130 also controls the source driver 160 to output a plurality of driving voltages VD corresponding to the display data LFD of the left eye frame, the display data RFD of the right eye frame, or the display data BFD of the black frame. The display panel 170 is coupled to the gate driver 150 and the source driver 160. In addition, the display panel 170 is driven by the scan signals SC to receive the driving voltages VD.

The signal processing unit 110 includes a data writing unit 111, a data reading unit 113, a black frame generating unit 115, and a time compensation unit 117. The data writing unit 111 is coupled to the memory unit 120 and receives the display data LFD of the left eye frame or the display data RFD of the right eye frame, so as to write the display data LFD of the left eye frame or the display data RFD of the right eye frame into the memory unit 120. The data reading unit 113 is coupled to the memory unit 120 and the black frame generating unit 115 to read the display data LFD of the left eye frame or the display data RFD of the right eye frame from the memory unit 120 and output the display data LFD of the left eye frame or the display data RFD of the right eye frame to the black frame generating unit 115.

The black frame generating unit 115 directly transmits the display data LFD of the left eye frame or the display data RFD of the right eye frame after receiving the display data LFD or the display data RFD. If the black frame generating unit 115 does not receive the display data LFD of the left eye frame or the display data RFD of the right eye frame, the black frame generating unit 115 outputs the display data BFD of the black frame. The time compensation unit 117 is coupled to the black frame generating unit 115 and the timing controller 130, so as to adjust brightness (i.e. gray scale values) of the display data (e.g. the display data LFD of the left eye frame or the display data RFD of the right eye frame) based on the writing-in time (i.e. the locations of the display panel 170 where the data are written) of the display data. Thereby, the brightness variation caused by time difference can be compensated.

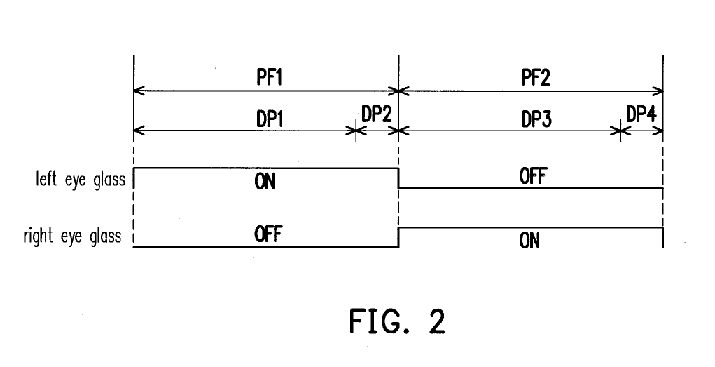

FIG. 2 is a time sequence diagram of driving a left eye glass and a right eye glass in a pair of shutter glasses depicted in FIG. 1 according to an embodiment of the invention. According to this embodiment as shown in FIG. 1 and FIG. 2, in a frame period PF1 (i.e. the left eye frame period), the left eye frame is displayed; in a frame period PF2 (i.e. the right eye frame period), the right eye frame is displayed. In a first display period DP1, the data reading unit 113 reads the display data LFD of the left eye frame from the memory unit 120, the black frame generating unit 115 transmits the display data LFD of the left eye frame to the time compensation unit 117, and the time compensation unit 117 adjusts the display data LFD and transmits the adjusted data to the timing controller 130.

The timing controller 130 controls the pair of shutter glasses 140 based on the display data LFD of the left eye frame, so as to open the left eye glass and shut the right eye glass. Besides, the timing controller 130, based on the display data LFD of the left eye frame, controls the gate driver 150 to generate the scan signals SC, so as to sequentially turn on each row of pixels in the display panel 170. The timing controller 130 also controls the source driver 160 to generate corresponding driving voltages VD that are applied to the turned-on pixels. As such, the display panel 170 displays the left eye frame, and the left eye glass of the pair of shutter glasses 140 is opened while the right eye glass is shut, so that the left eye receives the left eye frame.

Meanwhile, when the data writing unit 111 receives the display data RFD of the right eye frame, the data writing unit 111 directly writes the display data RFD into the memory unit 120. By contrast, when the data writing unit 111 receives the display data LFD of the left eye frame, the data writing unit 111 writes the display data LFD into the memory unit 120 after the display data LFD of the left eye frame are completely read from the memory unit 120.

In a second display period DP2, the data reading unit 113 does not read data from the memory unit 120, such that the black frame generating unit 115 cannot receive any display data. At this time, the black frame generating unit 115 generates the display data BFD of the black frame, i.e. the display data BFD having gray scale values at zero are continuously output. The display data BFD are adjusted by the time compensation unit 117 and then transmitted to the timing controller 130. The timing controller 130, based on the display data BFD of the black frame, controls the gate driver 150 to generate the scan signals SC, so as to turn on each row of pixels in the display panel 170. The timing controller 130 also controls the source driver 160 to generate the driving voltages VD corresponding to the display data BFD of the black frame and apply the driving voltages VD to turned-on pixels. Thereby, the display data BFD of the black frame can be written into the display panel 170. At this time, the black frame is displayed on the display panel 170.

When the display data BFD of the black frame are written into the display panel 170, it should be mentioned that the pixels arranged in row in the display panel 170 can be turned on row by row. Alternatively, multiple rows of pixels can be simultaneously turned on, which is similar to turning on pixels in one of the regions of the display panel 170 divided into a plurality of regions. It is also likely to turn on all of the pixels in the display panel 170 at the same time. Note that the shortest writing-in time can be accomplished when all of the pixels are simultaneously turned on, and the most favorable display quality can be achieved when the pixels are turned on row by row.

In a third display period DP3, the data reading unit 113 reads the display data RFD of the right eye frame from the memory unit 120, the black frame generating unit 115 transmits the display data RFD of the right eye frame to the time compensation unit 117, and the time compensation unit 117 adjusts the display data RFD and transmits the adjusted data to the timing controller 130. The timing controller 130 controls the pair of shutter glasses 140 based on the display data RFD of the right eye frame, so as to open the right eye glass and shut the left eye glass. Besides, the timing controller 130, based on the display data RFD of the right eye frame, controls the gate driver 150 to generate the scan signals SC, so as to sequentially turn on each row of pixels in the display panel 170. The timing controller 130 also controls the source driver 160 to generate corresponding driving voltages VD that are applied to the turned-on pixels. As such, the display panel 170 displays the right eye frame, and the right eye glass of the pair of shutter glasses 140 is opened while the left eye glass is shut, so that the right eye receives the right eye frame.

Meanwhile, when the data writing unit 111 receives the display data LFD of the left eye frame, the data writing unit 111 directly writes the display data LFD into the memory unit 120. By contrast, when the data writing unit 111 receives the display data RFD of the right eye frame, the data writing unit 111 writes the display data RFD into the memory unit 120 after the display data RFD of the right eye frame are completely read from the memory unit 120.

In a fourth display period DP4, the data reading unit 113, the black frame generating unit 115, and the timing controller 130 operate in the similar way to that in the second display period DP2, and therefore no further description is provided hereinafter. As discussed above, the left eye frame and the right eye frame are spaced by the black frame, and therefore color blending phenomenon does not occur in the left and right eye frames. As such, the left eye glass can be opened when the display data LFD of the left eye frame are written into the display panel 170, and the right eye glass can be opened when the display data RFD of the right eye frame are written into the display panel 170. The display time of frames is thus increased, and so is the brightness of the displayed frames.

As indicated in FIG. 2, in the second display period DP2, it is the black frame but not the image that is displayed, and therefore frame details can be ignored. In other words, the displayed frame can be nearly but not fully black, which significant reduces the second display period DP2. Hence, the second display period DP2 can be far shorter than the first display period DP1, so as to increase the writing-in time and the display time of the left eye frame. Similarly, the fourth display period DP4 is far shorter than the third display period DP3, so as to increase the writing-in time and the display time of the right eye frame. According to some embodiments of the invention, the first display period DP1 can be equal to the third display period DP3, and the second display period DP2 can be equal to the fourth display period DP4, such that the brightness of the left and right eye frames can be similar or the same.

For instance, when a frame refreshing frequency is at 120 Hz in a high-definition (HD) display panel having the 1280×720 resolution, the charging time for the pixels is substantially 10.3 μs or 7.38 μs if 5% or 32% of the frame period is reserved for displaying frames on a conventional 3D display. By contrast, the charging time for the pixels is substantially 9.45 μs in this invention. When a frame refreshing frequency is at 120 Hz in a full-HD display panel having the 1920×1080 resolution, the charging time for the pixels is substantially 7.33 μs or 5.24 μs if 5% or 32% of the frame period is reserved for displaying frames on a conventional 3D display. By contrast, the charging time for the pixels is substantially 6.72 μs in this invention.

Moreover, when the overdriving techniques are applied, the previous frame is fixed to be the black frame, i.e. the gray value of the previous frame is zero when the display data of the left eye frame or the display data of the right eye frame are written into the display panel. Hence, the overdriving table can be simplified to be a one-dimensional vector matrix, so as to reduce the memory space occupied by the overdriving table.

Since the display data LFD of the left eye frame and the display data RFD of the right eye frame are written into the display panel 170 in a row-by-row manner, the display time of the first row is slightly longer than that of the second row, the display time of the second row is slightly longer than that of the third row, and so on. Additionally, the display time of the first row is far longer than that of the last row, which leads to uneven brightness of the entire frame. At this time, the time compensation unit 117, based on the writing-in time (i.e. the writing-in sequence) of the display data, adjusts the gray scale values of the display data. In other words, the gray scale values of the display data can be adjusted based on the locations of the display panel 170 where the display data are written. Detailed descriptions are provided hereinafter.

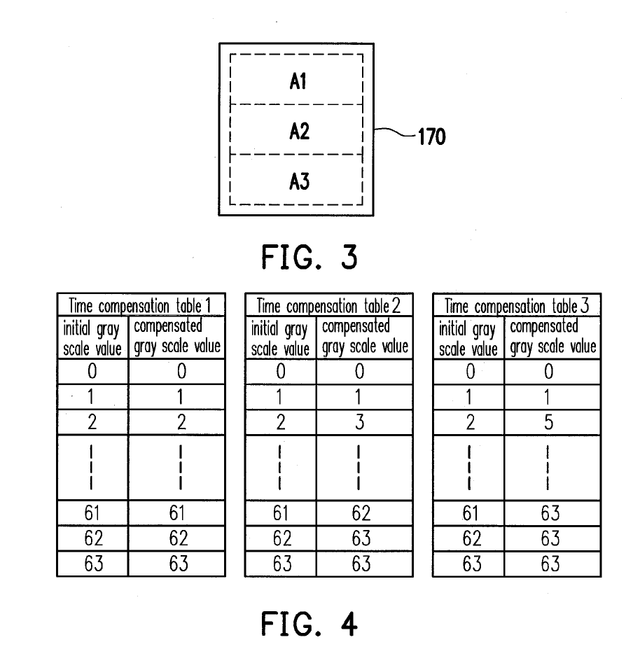

FIG. 3 is a schematic view illustrating regions of the display panel 170 depicted in FIG. 1 according to an embodiment of the invention. FIG. 4 is a schematic view illustrating a plurality of time compensation tables according to an embodiment of the invention. With reference to FIG. 3 and FIG. 4, the display panel 170 is divided into a plurality of regions (three regions A1, A2, and A3 are exemplarily shown in the drawings), and each of the regions A1, A2, and A3 corresponds to a time compensation table. Namely, the region A1 corresponds to the time compensation table 1, the region A2 corresponds to the time compensation table 2, and the region A3 corresponds to the time compensation table 3. The gray scale values of the time compensation tables 1, 2, and 3 exemplarily range from 0˜63, which should not be construed as limitations to this invention. It should be mentioned the number of rows in the regions A1, A2, and A3 can be the same or different. People having ordinary skill in the art can adjust the number of rows based on different types and properties of the display panels, which should not be limited in this invention.

When the location where the display data are written is in the region A1, the gray scale value is adjusted based on the time compensation table 1. When the location where the display data are written is in the region A2, the gray scale value is adjusted based on the time compensation table 2. When the location where the display data are written is in the region A3, the gray scale value is adjusted based on the time compensation table 3. As indicated in FIG. 4, the compensated gray scale values in the time compensation table 1 remain the same, some compensated gray scale values in the time compensation table 2 are greater than the initial gray scale values, and some compensated gray scale values in the time compensation table 3 are much greater than the initial gray scale values. Here, the compensated gray scale values at most reach the maximum gray scale value (e.g. 63). If the display data all have the same gray scale value, the brightness of the region A3 is greater than that of the region A2, and the brightness of the region A2 is greater than that of the region A1. Besides, the overall brightness of the regions A1, A2, and A3 is similar or the same because the display time of the region A1 is slightly longer than that of the region A2, and the display time of the region A2 is slightly longer than that of the region A3.

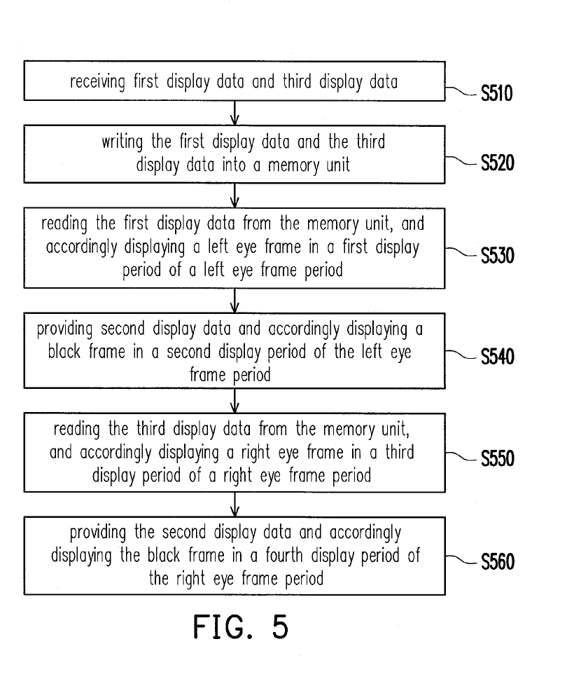

A display method of a 3D display (e.g. the 3D display 100) can be deduced from the above discussions. FIG. 5 is a flowchart illustrating a display method of a 3D display according to an embodiment of the invention. With reference to FIG. 5, first display data and third display data are received in step S510, and the first display data and the third are written into a memory unit in step S520. In a first display period of a left eye frame period, the first display data are read from the memory unit, and a left eye frame is displayed accordingly (step S530). In a second display period of the left eye frame period, second display data is provided and a black frame is displayed accordingly (step S540). In a third display period of a right eye frame period, the third display data are read from the memory unit, and a right eye frame is displayed accordingly (step S550). In a fourth display period of the right eye frame period, the second display data is provided and the black frame is displayed accordingly (step S560). Details of the steps can be learned from the descriptions provided hereinbefore. Note that the sequence of the steps is merely illustrative but does not limit the invention when the display method is actually applied.

In light of the foregoing, according to the 3D display and the display method thereof as described in the embodiments of the invention, the left eye frame and the right eye frame are spaced by the black frame, and the writing-in time and the display time of the black frame are shortened, so as to increase the writing-time and the display time of the left eye frame and the right eye frame. As such, the brightness and contrast of the left eye frame and the right eye frame can be enhanced, and the size of the overdriving table can be reduced. In addition, the display panel is divided into a plurality of regions, display data are written into each of the regions, and the gray scale values of the display data written into each of the regions can be adjusted based on the corresponding time compensation table. Thereby, uniformity of the displayed frames can be ensured.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A display method suitable for a three-dimensional display having a memory unit, the display method comprising:
reading first display data frame from the memory unit in a first display period of a left eye frame period and displaying a left eye frame accordingly;
providing second display data in a second display period of the left eye frame period and displaying a black frame accordingly;
reading third display data frame from the memory unit in a third display period of a right eye frame period and displaying a right eye frame accordingly; and
providing the second display data in a fourth display period of the right eye frame period and displaying the black frame accordingly.

2. The display method as claimed in claim 1, wherein the step of displaying the left eye frame comprises:
opening a left eye glass of a pair of shutter glasses and shutting a right eye glass of the pair of shutter glasses in the three-dimensional display; and
writing the first display data into a display panel of the three-dimensional display.

3. The display method as claimed in claim 1, wherein the step of displaying the right eye frame comprises:
opening a right eye glass of a pair of shutter glasses in the three-dimensional display and shutting a left eye glass of the pair of shutter glasses; and
writing the third display data into a display panel of the three-dimensional display.

4. The display method as claimed in claim 1, wherein the second display period is shorter than the first display period, and the fourth display period is shorter than the third display period.

5. The display method as claimed in claim 1, wherein the first display period is equal to the third display period, and the second display period is equal to the fourth display period.

6. The display method as claimed in claim 1, wherein the second display data are written row by row into a display panel of the three-dimensional display.

7. The display method as claimed in claim 1, wherein the second display data are simultaneously written into a plurality of pixels in a display panel of the three-dimensional display.

8. The display method as claimed in claim 1, wherein a display panel of the three-dimensional display is divided into a plurality of display regions, and the second display data are sequentially written into each of the display regions of the display panel.

9. The display method as claimed in claim 1, wherein a display panel of the three-dimensional display is divided into a plurality of display regions, each of the display regions respectively corresponds to a time compensation table, the first display data, the second display data or the third display data are written into each of the display regions, and gray scale values of the display data written into each of the display regions are adjusted based on the corresponding time compensation table.

10. The display method as claimed in claim 1, further comprising:
receiving the first display data and the third display data; and
writing the first display data and the third display data into the memory unit.
